(19) United States
(12) Patent Application Publication
(10) Pub. No.: US 2015/0310443 A1
(43) Pub. Date: Oct. 29, 2015

(54) SECURE MANAGEMENT OF A PROVISION OF SERVICE TRANSACTION

(71) Applicants: Guillaume THOMASSON, (US); Edouard BLIN, Paris (FR)

(72) Inventor: Guillaume Thomasson, Bourdeau (FR)

(73) Assignees: Guillaume Thomasson, Bourdeau (FR); Edouard Blin, Paris (FR)

(21) Appl. No.: 14/650,149

(22) PCT Filed: Dec. 3, 2013
(86) PCT No.: PCT/EP2013/075421

§ 371 Date: Jun. 5, 2015

(30) Foreign Application Priority Data
Dec. 7, 2012 (FR) 1261753

(51) Int. Cl. G06Q 20/40; H04W 4/00; G06Q 20/32; G06Q 30/00

(52) U.S. Cl. CPC G06Q 20/40145; G06Q 30/012; H04W 4/001; G06Q 20/325; G06Q 20/3224

(57) ABSTRACT

Method of managing a transaction relating to a provision of service between a requester and a service provider, characterized in that it includes the following steps:
biometric identification of the service provider on the basis of a remote communication between a portable object, such as a mobile telephone (30), of the service provider and a server (10) of the service provision transaction management system;
location of a portable object of the service provider and transmission of location data to a server (10) of the service provision transaction management system via a remote communication;
verification of the biometric identification, verification of the place and the date and validation of the provision of service by a server (10) of the service provision transaction management system.

The invention concerns a method of managing transactions for the execution of a provision of service and a system that implements such a method.

Today there exist numerous Internet sites enabling a vendor and a purchaser to communicate in order to execute a sale of a given object. However, these solutions are not suitable for the execution of a transaction linked to provisions of service. By transaction is meant the signing of a contract, the outcome of an agreement between two parties, specifically for the execution of a provision of service in the context of this invention.

For the management of provisions of service there exist for example sites for establishing communication between a service provider and a requester. The latter must then necessarily be present during the execution of the transaction to be sure that it is the correct other party, to verify the correct execution of the provision, before making the payment. For the requester this solution has the drawback of necessarily attending the provision. Moreover, the service provider must have confidence in the requester, as their payment is not guaranteed. Other solutions necessitate the use of complex devices to guarantee the identity of the persons and the secure payment. Other solutions are particularly suited to a particular provision of service and cannot be generalized because of their specifics.

The existing solutions for managing transactions involving provisions of service are therefore inadequate and do not allow the widespread development of service provision transactions, notably on a person to person basis.

A general object of the invention is therefore to propose a solution enabling the sale of provisions of service in a manner that is user friendly, secure and simple, without necessitating complex devices.

To this end, the invention relies on a method of managing a transaction relating to a provision of service between a requester and a service provider, characterized in that it includes the following steps:
biometric identification of the service provider and/or the beneficiary of the provision of service on the basis of a remote communication between a portable object, such as a mobile telephone, of the service provider and/or the beneficiary of a provision of service and a server of the service provision transaction management system;
location of a portable object of the service provider and/or the beneficiary of a provision of service and transmission of location data to a server of the service provision transaction management system via a remote communication;
verification of the biometric identification(s), verification of the place and the date and validation of the provision of service by a server of the service provision transaction management system.

The server of the service provision transaction management system may execute the following steps:
storing in an electronic memory a contract entered into between a service provider and a requester following the communication between them;
during the provision of service, validating this provision only after a verification step comprising the automatic association with a pre-stored contract of the identification, location and date data received.

The method of managing a transaction may include a supplementary step of remote transmission of a green light to the service provider and/or to the beneficiary for the execution of the provision of service in the event of successful verifications.

The biometric identification step may be a voice identification step that includes the reading out of a phrase by the provider and/or the beneficiary on a mobile telephone, a voice recognition procedure executed at least partly on a server of the service provision transaction management system and/or partly on the mobile telephone.

The voice identification step may include the transmission of a phrase from the server of the service provision transaction management system to a mobile telephone of the provider, then the reading out loud of this phrase by the provider, and then the execution of the voice recognition procedure on the basis of this reading out.

The method of managing a transaction may include a complementary step of authentication of the portable object of the provider by the server of the service provision transaction management system.

The server of the service provision transaction management system may execute a step of automatic association of the data received with a pre-stored contract.

The method of managing a transaction may execute at least one other step of identification of the provider and of location during the execution of the provision and/or at the end of that execution.

The service provision transaction management system may, after the end of the provision of service, execute a step of payment of the provider by delivering to the provider the payment of the requester corresponding to the contract the transaction concerns.

The method of managing a transaction may execute a step of requesting from the requester a parameter representing the level of confidence required for a transaction or may include automatic determination of the level of confidence of a transaction as a function of some or all of the following criteria:
the nature of the provision,
the identity of the provider and their personal confidence index, estimated as a function of their past service provisions,
the overall cost of the transaction.

The method of managing a transaction may execute some or all of the following steps to achieve a required level of confidence:
calculation of the duration of the provision from stored start and end times of the provision;
identification of the provider by complementary personal questions and/or by identification on a server via an Internet connection;
random or periodic location of the provider;
production of certain photos at the end of provision by the provider and sending to the server of the service provision transaction management system;
identification and/or location of a supplementary person, such as the requester who participates in the provision.

The method of managing a transaction may include a preliminary phase of entry of personal data from the following list by a service provider followed by storing this data in a service provider database;
an identity, in the form of a biometric identifier, such as a voiceprint,
the authentication of a portable communication device,
the nature of the provision of service offered,
available time bands, dates, for executing a provision of service,
places, geographical limits for the execution of the provision of service,
banking details for receiving the payments.

The method of managing a transaction may include a preliminary phase of entry of some or all of the following data into a database by a requester of a provision of service:
an identity, such as a biometric identifier,
the nature of the provision requested,
the required time bands and/or dates,
the place,
banking data for proceeding to the payment.

The method of managing a transaction may include a step of the service provision management server storing in an electronic memory data linked to the execution of a provision of service transaction to preserve the digital traceability of the contracts entered into.

The server of the service provision transaction management system may associate a digital signature or a digital certificate at least with the biometric identification data to guarantee non-repudiation of the transaction in the future.

The invention also relates to a system for managing a transaction relating to a provision of service between a requester and a service provider, comprising at least one server and an associated electronic memory, characterized in that the server executes the method as described above of managing a transaction.

The invention further relates to a computer medium containing a computer program executing the steps of the method as described above of managing a transaction involving a provision of service between a requester and a service provider.

These objects, features and advantages of the present invention are described in detail in the following description of one particular embodiment given by way of nonlimiting example with reference to the appended FIGURE which represents diagrammatically a system in accordance with one embodiment of the invention.

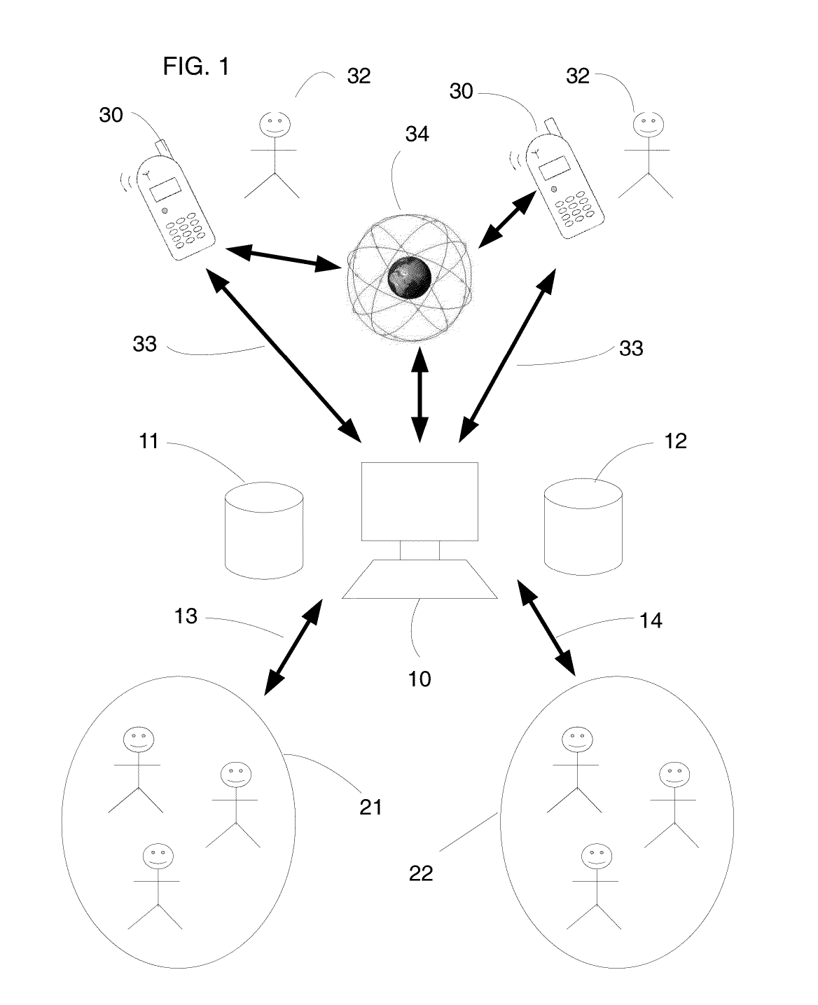

This FIG. 1 service provision transaction management system is based on a central platform that includes a server 10 associated with at least one electronic memory, for example one or more databases. In the embodiment represented, a first database 11 corresponds to a list 21 of persons offering a provision of service and a second database 12 corresponds to a list 22 of persons purchasing provisions of service.

These various persons 21, 22 can communicate with the server 10 via any communication devices, for example via an Internet connection, from any personal device, such as a computer or simple portable personal object such as a telephone 30, using any means to establish a remote communication 13, 14. The server 10 therefore enables them to specify their offer and their request, respectively, via a man-machine interface.

In the service provider database 11, each person provides the following data:
an identity, in the form of a voiceprint, or even any other type of biometric identifier, as described in detail hereinafter,
personal information allowing their optional additional, or even replacement, identification,
an authentication of a portable communication device, notably at least its mobile telephone number or the IMEI number of its SIM card,
the nature of the provision of service offered,
dates and time bands for offering this service,
places, geographical perimeters for the execution of the service,
banking details for receiving the payments, etc.

To raise the level of security in the management of this data, complementary security steps may optionally be implemented such as electronic certification of the voice biometric identifier, which consists in an electronic signature of this identifier by an encryption procedure, in known manner, that guarantees its authenticity on subsequent use. For this purpose, the server 10 preferably calls on a separate and dedicated certification centre. Moreover, their mobile telephone may also be stored securely, enabling certification of its future authentications.

Requesters from the database 12 may have entered the following data:
an identity,
a biometric identity of one or more beneficiaries of the provision of service,
the nature of the provision requested,
the required time bands,
the place, or a geographical limit,
banking data for making payments.

The central server 10 then includes software enabling at least partial automation of the communication between the provision of service offered and requested on the basis of the foregoing information, for example by cross-referencing the nature of the provision and the time and geographical information, to inform the requester automatically of the existence of certain possibilities corresponding to their requirements.

Alternatively, or as an optional add-on, the server may offer the requester a search tool enabling them to carry out a simple and user friendly search for a service provider corresponding to their requirements, via a man-machine interface.

Alternatively, the management system may function with only one of the two databases, either the service provider database or the requester database. For example, the system may offer provisions of service for sale, storing only a service provider database 11. Then, persons seeking a provision of service can consult this data via a man-machine interface to execute a search to identify the provisions that might suit them. A requester will then identify himself by entering data similar to that referred to above for the requester database 12 in order to enter into a service provision contract with the chosen provider.

In all cases, when a requester and a service provider communicate in order to execute a provision of service, a service provision contract between the requester and the provider is entered into. A transaction code is then created and the transaction is stored in a memory of the server 10 for example in a third database, not shown. There are in particular stored for each transaction the identities of the two parties, and notably the identity of the service provider who is to execute the provision and/or the identity of the beneficiary or beneficiaries of the provision, a date, time band, week, or more generally information on the intended moment for the execution of this provision and geographical information, that is to say the place where the provision must be executed. For simplicity, the term “date” of the transaction will be used in a broad sense, including any information as to the moment of the provision, which may be a precise date or a less precise date, such as a time band of a particular day, a week, etc.

At the stage of finalizing this contract, the requester can indicate a minimum level of confidence they require to accept the execution of the provision of service. Alternatively, the transaction management method can automatically fix an index of confidence threshold as a function of predefined criteria, for example on the basis of the identity of the parties involved (provider and/or beneficiary) and/or the nature of the provision and/or the cost of the provision.

In fact, a first serious technical problem in the execution of a provision of service is to be able to guarantee that the provision is executed in the intended manner as expected by the requester, even in their absence, and/or without knowing the provider, for them to accept to enter into the contract and then to pay for this provision with a certain confidence. Conversely, the service provider may execute the provision, even in the absence of the requester, with high confidence, their payment being guaranteed by the system. Such a mechanism is necessary to enable the development of a strong activity in terms of sales of services between a very large number of persons who do not know each other, even between private individuals, and for any type of provision of service. This confidence problem can therefore be solved in one direction only, toward the requester, or in a crossover manner, toward the requester and the service provider, so that the two parties to the transaction can have confidence in it.

A second technical problem makes it necessary to be able to execute this provision of service without recourse to complex and costly devices, to enable the simplest possible accessibility to it by a large number of persons.

The invention therefore relates specifically to a solution for the execution of such a provision of service that addresses the two technical problems mentioned above.

To this end, in accordance with one embodiment, the method of managing the transaction relating to a provision of service, executed by software on the server 10, includes a first step of identification of the provider and a second step of location of that provider, at the moment of the execution of the provision of service. This approach makes it possible to guarantee that this is the correct service provider, under the terms of a certain coded and stored provision of service contract, and that they are at the correct location at an intended time.

When a service provider 32 has reached the place where they must execute a provision of service, they start with a first step of identification. To this end they set up a simple telephone call using a mobile telephone 30 and a voice recognition identification procedure is executed.

This voice recognition procedure may be executed entirely by the remote server 10 or partly in software in the mobile telephone 30. At the time of this procedure, the server may for example transmit a random phrase to the service provider, orally by telephone or by SMS text or electronic mail. The provider who receives this phrase must read it out loud into their mobile telephone to be identified. In accordance with a variant embodiment, to prevent fraud this reading must be carried out within a certain time limit.

This identification step is obligatory. Its biometric execution by way of voice recognition makes it possible to arrive at an ideal compromise between the reliability of the identification and the simplicity of the procedure, since a simple mobile telephone is sufficient, together with reasonable computation power installed on the server, using for this purpose any known voice recognition algorithm.

Alternatively, some other form of biometric identification may be chosen, such as fingerprint verification or face recognition, again executed via a mobile telephone.

Additionally, this identification of the provider may be combined with the authentication of their mobile telephone to achieve a higher level of confidence. The telephone number may suffice for this, or a more elaborate authentication procedure may be executed on the basis of the IMEI code stored on the SIM card of the telephone, for example.

Thus in a sophisticated variant embodiment the voice of the provider and an item of data from their telephone may be matched and used to generate a combined digital signature, which is then verified by the central server 10, or by a signature certification centre. In the latter case, the service provider server 10 enters into a call with the signature verification server and receives in return the validation or rejection of the signature.

If the service provider has forgotten their telephone or if its battery is dead, they may use any other telephone to execute their voice recognition. However, in situations where this is insufficient to achieve the required level of confidence, it is possible to execute alternative steps to increase the level of confidence, such as questions regarding personal data of the provider, for example. Such possibilities are described hereinafter.

Complementing the identification step described above, a second step of location is executed, for example by a GPS device integrated into the mobile telephone or by simple triangulation by the telephone system. Location data is then transmitted automatically to the central server.

When the server 10 receives this identification and location data, it automatically establishes the link between a contract that has been entered into and stored, which must correspond to the identity of the provider, the date and the place. In the event of doubt as to the contract, the server requests additional information from the service provider and/or the beneficiary to be sure of identifying the transaction with certainty. The server then verifies the level of confidence associated with this contract and executes complementary verification steps if necessary.

When this phase has finished, the server sends a green light to the telephone of the provider, who knows that they may execute the agreed provision. In all cases, the server executes a step of time and date stamping and certifying the received data, which guarantees its integrity throughout the procedure.

With no green light either the provision must not be executed because the payment will not be guaranteed or the provision is executed with no guarantee of payment.

This phase preceding the provision of service therefore has the advantage of great simplicity, because one or more simple telephone calls 33 suffice, using a simple mobile telephone.

When the provision of service is completed, the provider can execute the following steps during a final phase of the provision:
the provider sending the server an end of provision message from their telephone, by means of a telephone call, SMS text or electronic mail, for example;
new identification by voice recognition and new location, to guarantee that it is still the right person;
the server storing the date and time of the end of the provision.

The method of managing the transaction can execute other steps to improve the level of confidence index for the transaction. In these supplementary steps the decision is arrived at automatically, as a function of some or all of the following criteria:
the nature of the provision,
the identity of the provider and their personal index of confidence, estimated as a function of their past provisions of service, for example, which can be evaluated a posteriori by requesters,
the overall cost of the transaction.

The other steps making it possible to increase the level of confidence of a transaction may be some or all of the following steps:
calculation of the duration of the provision from the stored start and end times;
identification of the provider and/or the beneficiary may be completed by complementary personal questions, by identification at the server 10 or another server via an Internet connection, by an identifier/password type system and/or by the response to personal questions;
intermediate supplementary identifications, during the execution of the provision, requested by random telephone calls from the server 10, for example; this approach may be useful when the provision is long, to be sure that the provider is still in the process of executing the provision; this approach may be combined with location of the provider;
random or periodic location of the provider, enabling their movements to be detected; a lack of movement on their part would be an index of inactivity, which may be incompatible with the execution of certain provisions;
production of certain photos by the provider at the end of provision, using their mobile telephone, for example, and sending them to the server 10, or even directly to the requester; the latter can therefore validate the result in real time, or the photos may simply be stored for verification in the event of subsequent requirements; such an approach may be useful in the case of provisions relating for example to mowing a lawn, painting a wall, etc;
by an identification of a supplementary person participating in the provision, for example when a piano lesson is given by a service provider to a third person, for example if the beneficiary of the provision of service is a child of the requester; the latter may then wish to verify at the start of provision that their child is at the intended place and identify them, in a similar manner to the identification of the provider explained above; the subject of this supplementary identification may also be that of the requester himself, to strength the confidence of the service provider who then knows that they are dealing with the correct client, who made the request for the provision of service; this supplementary identification may be executed on the basis of a biometric identifier, in a manner similar to the identification of the service provider; in a variant of the embodiment of the invention, the identification of the beneficiary of the provision of service may suffice; for example, if the beneficiary is at a place belonging to the service provider, it may be considered that their identification at that place is sufficient to achieve sufficient confidence for the execution of the provision of service, without necessarily requiring the identification of the service provider himself, who may moreover in some cases be visually identified by the beneficiary of the provision of service; to give another example, regardless of the place of the transaction, the choice may be made to identify only the beneficiary of the provision if the nature of the provision more particularly requires the confidence of the service provider.

These various steps intended to increase the level of confidence of the transaction may be obligatory for some particular provisions. For example, if the transaction relates to a duration of service, such as a certain number of hours of cleaning, it is strongly recommended that the duration of the provision be taken into account, by storing the start and end times.

These steps make it possible and simple to achieve a satisfactory level of confidence. By the possible combination of these various steps, a plurality of levels of confidence are possible for the same transaction. Thus the requester may demand a certain level of confidence and/or the management system may impose a certain minimum level of confidence for a certain transaction. When it is a question of provisions of service repeated with the same provider, the requester may reduce the level of confidence over time, as their confidence increases with their knowledge of the provider and the validation over time of their competence and the quality of their provision.

The foregoing approach is a good response to the objects looked for, and therefore represents a good compromise for achieving a satisfactory level of confidence at the time of the execution of a provision, without requiring a costly infrastructure but rather by the simple use of devices in very widespread use such as a mobile telephone. More generally, any intelligent and communicating portable object may be suitable, such as a tablet, a laptop computer, a radio, for example a vehicle radio, etc. Nevertheless, the system described is not incompatible with the use of more complex means and this solution may be combined with any other existing complementary solution, for example on the basis of highly secure transaction terminals.

Moreover, the system described with reference to FIG. 1 can naturally have a different architecture, employing a plurality of remote servers sharing the various functions described, based on any form of electronic memory that can be connected or not to a certain server. By server is meant any processor device, computer, communicating remotely to execute the method described above.

When the provision of service is finished and has been effected in accordance with all the intended steps and with success to achieve the required level of confidence, the payment for the provision is executed automatically. The server then serves as an intermediary, proceeds to pay the provider and takes care of the automatic billing of the requester, as well as logging the financial transaction to receive the payment for the provision. In this way the provider is also in a situation of confidence because they are sure of being paid if they have carried out all the steps described above. Note that this payment remains optional, the method possibly suiting provisions of service that do not entail a payment, such as simply putting persons in contact, notably with a view to a safe meeting. The invention does not relate to a method of payment, but to a method enabling the execution of provision of service in a secure environment and with confidence between the parties.

A history of all the contracts and transactions executed is held in a memory associated with the server, with all the information mentioned above relating to the transaction. The system therefore enables tracking of transactions and the integrity of the stored data, whereby the transactions cannot be repudiated.

The foregoing description has shown how a method can make it possible to address the specific technical problem of connecting persons for the execution of a provision of service.

A problem of confidence arises for the execution of any transaction between persons, notably for the sale of valuable objects between two persons who do not know each other or simply a meeting of two persons who do not know each other. A similar solution can make it possible to provide a technical solution to such a situation. In fact, the two persons may communicate remotely using a management system similar to that described above and enter into a contract defining a subject for their meeting (a transaction in the broad sense), for example the sale of an object at an agreed price or simply a meeting, at a certain date and at a certain place.

The solution would then be based on a method of managing such a transaction characterized in that it includes the following steps:
biometric identification of the two persons via a remote communication between a portable object, such as a mobile telephone, of the two persons and a server of the transaction management system;
location of a portable object of at least one of the two persons and transmission of location data to a server of the transaction management system via a remote communication;
verification of the biometric identification, verification of the place and the date and validation of the execution of the transaction by a server of the transaction management system.

The server of the transaction management system may then execute the following steps:
storing in an electronic memory a contract between two persons entered into following the communication between them;
during execution of the transaction, validation of this transaction only after a verification step comprising the automatic association with a pre-stored contract of the identification, place and date data received.

1. Method of managing a transaction relating to a provision of service between a requester and a service provider comprising:
performing a biometric identification of at least one of (i) the service provider and (ii) a beneficiary of a provision of service based on a remote communication between a portable object of at least one of (i) the service provider and (ii) the beneficiary of the provision of service and a server of a service provision transaction management system;
locating the portable object of at least one of (i) the service provider and (ii) the beneficiary of the provision of service and transmitting the location data to the server of the service provision transaction management system via a remote communication;
verifying the biometric identification, verifying a place and a date, and validating the provision of service by the server of the service provision transaction management system.

2. Method of managing a transaction according to claim 1, wherein the server of the service provision transaction management system executes the following steps:
storing in an electronic memory a contract entered into between the service provider and a-the requester following a communication between them;
during the provision of service, validating the provision of service only after performing a verification step comprising an automatic association between a pre-stored contract and the biometric identification, the place, and the date data received.

3. Method of managing a transaction according to claim 1, comprising a supplementary step of remotely transmitting a green light to at least one of (i) the service provider and (ii) the beneficiary for executing the provision of service in the event of successful verifications.

4. Method of managing a transaction according to claim 1, wherein the biometric identification step is:
a voice identification step that includes reading a spoken phrase on a mobile telephone, the phrase being transmitted from the server of the service provision transaction management system to the portable object of at least one of (i) the service provider and (ii) the beneficiary of the provision of service or predefined beforehand, then executing a voice recognition procedure based on the reading, wherein the voice recognition procedure is at least one of (i) at least partly executed on a server of the service provision transaction management system and (ii) partly executed on the mobile telephone; or
a biometric identification step by face recognition, wherein the biometric identification step by face recognition is at least one of (i) at least partly executed by the server of the service provision transaction management system and (ii) partly executed on the portable object;
a fingerprint-based biometric identification step, wherein the fingerprint-based biometric identification step is at least one of (i) executed at least partly on the server of the service provision transaction management system and (ii) partly executed on the portable object.

5. Method of managing a transaction according to claim 1, comprising a complementary step of authenticating the portable object of at least one of (i) the service provider and (ii) the beneficiary of a provision of service by the server of the service provision transaction management system.

6. Method of managing a transaction according to claim 1, comprising at least one other step of identifying the service provider and of locating, at least one of (i) during the execution of the provision of service and (ii) at the end of the execution of the provision of service.

7. Method of managing a transaction according to claim 1, wherein the service provision transaction management system executes a step of triggering a payment of the provider by delivering to the service provider the a payment by the requester corresponding to a contract with which the transaction concerns.

8. Method of managing a transaction according to claim 1, comprising a step of requesting from the requester a parameter representing a level of confidence required for the transaction or a step of automatically determining the level of confidence of the transaction as a function of some or all of the following criteria:
a nature of the provision,
an identity of the service provider and a personal confidence index of the service provider, estimated as a function of past service provisions of the service provider,
an overall cost of the transaction.

9. Method of managing a transaction according to claim 8, comprising executing some or all of the following steps to achieve a required level of confidence:
calculating a duration of the provision from stored start and end times of the provision;
identifying the service provider by at least one of (i) complementary personal questions and (ii) identification on the server via an Internet connection;
randomly or periodically locating the provider;
producing photos at an end of the provision by the service provider and sending to the server of the service provision transaction management system; and
at least one of (i) identifying and (ii) locating a supplementary person who participates in the provision.

10. Method of managing a transaction, characterized in that it includes according to claim 1, comprising a preliminary phase of entering personal data from the following list by the service provider followed by storing the personal data in a service provider database:
an identity, in the form of a biometric identifier,
an authentication of a portable communication device,
a nature of the provision of service offered,
available time bands, dates, for executing the provision of service,
places, geographical limits for the execution of the provision of service,
banking details for receiving payments.

11. Method of managing a transaction according to claim 1, comprising a preliminary phase of entering some or all of the following data into a database by a the requester of the provision of service:
an identity, in the form of a biometric identifier,
an identity of at least one beneficiary of the provision of service,
a nature of the provision requested,
required time bands and/or dates,
a place,
banking data for proceeding to a payment.

12. Method of managing a transaction according to claim 1, comprising a step of the service provision management server storing in an electronic memory data linked to the execution of the provision of service transaction to preserve digital traceability of a contract entered into.

13. Method of managing a transaction according to claim 1, wherein the server of the service provision transaction management system associates a digital signature or a digital certificate at least with the biometric identification data to guarantee non-repudiation of the transaction in the future.

14. System for managing a transaction relating to the provision of service between the requester and the service provider, comprising:
at least one server and
an associated electronic memory,
wherein the server executes the method of managing a transaction according to claim 1.

15. Computer medium containing a computer program executing the method according to claim 1 of managing the transaction involving the provision of service between the requester and the service provider.

16. Method of managing a transaction according to claim 2, comprising a supplementary step of remotely transmitting a green light to at least one of (i) the service provider and (ii) the beneficiary for executing the provision of service in the event of successful verifications.

17. Method of managing a transaction according to claim 2, wherein the biometric identification step is:
a voice identification step that includes reading a spoken phrase on a mobile telephone, the phrase being transmitted from the server of the service provision transaction management system to the portable object of at least one of (i) the service provider and (ii) the beneficiary of the provision of service or predefined beforehand, then executing a voice recognition procedure based on the reading, wherein the voice recognition procedure is at least one of (i) at least partly executed on a server of the service provision transaction management system and (ii) partly executed on the mobile telephone; or
a biometric identification step by face recognition, wherein the biometric identification step by face recognition is at least one of (i) at least partly executed by the server of the service provision transaction management system and (ii) partly executed on the portable object;
a fingerprint-based biometric identification step, wherein the fingerprint-based biometric identification step is at least one of (i) executed at least partly on the server of the service provision transaction management system and (ii) partly executed on the portable object.

18. Method of managing a transaction according to claim 2, comprising a complementary step of authenticating the portable object of at least one of (i) the service provider and (ii) the beneficiary of a provision of service by the server of the service provision transaction management system.

19. Method of managing a transaction according to claim 2, comprising a step of requesting from the requester a parameter representing a level of confidence required for a transaction or a step of automatically determining the level of confidence of the transaction as a function of some or all of the following criteria:
a nature of the provision,
an identity of the service provider and a personal confidence index of the service provider, estimated as a function of past service provisions of the service provider,
an overall cost of the transaction.

20. Method of managing a transaction according to claim 19, comprising executing steps to achieve a required level of confidence,
wherein the steps comprise some or all of:
calculating a duration of the provision from stored start and end times of the provision;
identifying the service provider by at least one of (i) complementary personal questions and (ii) identification on the server via an Internet connection;
randomly or periodically locating the provider;
producing photos at an end of the provision by the service provider and sending to the server of the service provision transaction management system; and
at least one of (i) identifying and (ii) locating a supplementary person who participates in the provision.
